(19) United States
(12) Patent Application Publication
(10) Pub. No.: US 2019/0360270 A1
(43) Pub. Date: Nov. 28, 2019

(54) Retractable Ladder Assembly for a Mechanical Closure Device

(71) Applicant: Art Metal Industries, New Milford, CT (US)

(72) Inventor: Kevin Biebel, New Milford, CT (US)

(21) Appl. No.: 16/372,873

(22) Filed: Apr. 2, 2019

Related U.S. Application Data
(60) Provisional application No. 62/651,761, filed on Apr. 3, 2018.

(51) Int. Cl. E06C 1/34; E06C 7/00; E06C 7/02

(52) U.S. Cl. CPC E06C 1/34; E06C 7/02; E06C 7/006

(57) ABSTRACT

A retractable ladder assembly comprising a lower frame fixed below an enclosure for a mechanical closure device and a moveable upper frame. The upper frame is disposed below the enclosure or removed entirely from the enclosure when not in use to prevent access from unauthorized personnel. The lower end of the upper frame engages the upper end of the lower frame and a link member on the upper frame engages an anchor within the enclosure to establish an extended ladder mode.

### CROSS-REFERENCE TO RELATED APPLICATION

This application claims the priority of U.S. Provisional Patent Application No. 62/651,761 filed on Apr. 3, 2018, the disclosure of which is incorporated herein by reference in its entirety.

### BACKGROUND

This disclosure relates generally to retractable ladders for use with a mechanical closure device (hereafter “MCD”). More particularly, this disclosure relates to retractable ladders that are partially fixed in a vertical position for use generally in permanent installations wherein periodic access to a different level is required, especially below-grade openings in urbanized environments that include an MCD.

Mechanical closure devices have been advanced to passively protect openings from being deluged with flood waters. In particular, subway system vent shafts and other below ground openings may be very vulnerable to water inundation during flooding conditions and coastal storm surges. The MCD is relatively easily installed beneath a street level grate and easily removed for maintenance and storage purposes when conditions so warrant. Once installed, the MCD is secured in place, making it resistant to vandalism and to attempts to remove or change the functional mode of the MCD without proper authorization. The MCD can be easily operated to close the floodgates by authorized personnel when conditions dictate. The MCD easily transforms between opened and closed positions and provides a closure function which provides a high degree of sealing integrity when the MCD doors are closed during flooding or imminent flooding conditions.

The mechanical floodgate assembly is easily removed from the enclosure for maintenance. Retractable ladders exist for use in installations and on heavy machinery to store the ladder when not in use, but there exists a need for ladders that can accommodate heavy use, remain easily accessible for specific personnel, prevent access to the average person, can be completely hidden from view below a grate or other cover in the sidewalk or street, and are compatible with an MCD.

### SUMMARY

Briefly stated, a retractable ladder assembly is mounted to a wall below an enclosure for a mechanical closure device. The ladder assembly comprises a lower frame and an upper frame, each having two parallel side rails extending from a proximal end to a distal end along and spaced apart from the wall. A plurality of rungs is disposed between the side walls. A channel member is attached to each of the side walls. The lower frame has plurality of adjustable bracket assemblies mounted to the side rails fixing the lower frame to the wall. A peg projects toward the enclosure from the proximal end of each of the lower side rail. The upper frame has a pocket complementary to the peg at the distal end of each of the side rails. A link member is rotatably secured to the upper frame. The channel members attached to the lower frame protrude away from the wall. The channel members attached to the upper frame protrude toward the wall. The channel members of the upper frame and the channel members of the lower frame laterally retain the upper frame to the lower frame. In a retracted position, the upper frame is retained to the lower frame, and in an extended position, each peg mates with each pocket to support the upper frame on the lower frame in a genera upright position, and the link member fastens to an anchor within the enclosure.

The upper frame preferably comprises a frame extension that slides from within the upper frame and locks in an expanded position. A pin fastens the link member to the anchor. Each adjustable bracket assembly preferably comprises a strut that slides into the slotted sleeve. The strut defines at least one hole which receives a fastener to secure the strut within the slotted sleeve. The upper frame is moved to the extended position so that the distal end of the upper frame is guided over into engagement with each peg. An appendage comprises a stop mounted to the lower frame and provides vertical limit for the upper frame to rest against in the retracted position.

The frame extension further comprises a pair of side walls and at least one rung. The frame extension is fixed in the expanded position by a pin that engages the upper frame.

A T-shaped tool having a rod-like handle and a coupler is engageable with the upper frame for pulling the upper frame toward and through the enclosure.

A retractable ladder assembly for use in an enclosure that accommodates a mechanical closure device comprises a lower frame permanently fixable to a wall below the enclosure. The lower frame has a plurality of side walls extending from a proximal end to a distal end and a plurality of rungs extending between the side walls. An upper frame has a plurality of side walls extending from a proximal end to a distal end and a plurality of rungs extending between the side rails.

A link member is pivotally mounted to the upper frame. The distal ends of the upper frame have a first structure which is complementary to a second structure at the proximal end of the side rails of the lower frame. The first and second structures releasably engage the distal end of the upper frame and the proximal ends of the lower frame in an extended position to support the upper frame on the lower frame. The link member is engageable to an anchor within the enclosure to define a stable installed state.

The upper frame is preferably made from aluminum and the lower frame is preferably made from stainless steel. A pin secures the link member to the anchor. The lower frame is mountable to the wall by a plurality of adjustable bracket assemblies, each comprising a strut that slides into a sleeve and is securable therewith. A frame extension slides within the upper frame and comprises a pair of side walls and at least one rung.

Each second structure of the side rails of the lower frame comprises a projecting member and each first structure of the distal end of the upper frame forms a generally complementary cavity which receives a projecting member. A guide structure guides each distal end of the upper frame over the proximal ends of the lower frame for engaging each distal end of the upper frame with each proximal end of the lower frame in an upright supported relationship.

A retractable ladder assembly for use in an enclosure that accommodates a mechanical closure device comprises a lower frame permanently fixable to a wall below the enclosure. The lower frame has a pair of side walls extending from a proximal end to a distal end and a plurality of rungs disposed between the side rails. An upper frame has a pair of side rails extending from a proximal end to a distal end and a plurality of rungs disposed between the side rails. A link member is rotatably mounted to the upper frame between the proximal end and the distal end. The distal ends of the upper frame have a structure complementary to the proximal ends of the side rails of the lower frame.

Retainer structures extend from the lower frame and the upper frame to laterally retain the lower frame and the upper frame in a retracted position. The upper frame is slidably moveable to an extended position and the structures of the side rails of the upper frame releasably engage the proximal ends of the side rails of the lower frame to support the upper frame on the lower frame in a generally upright orientation, and the link member is engageable to an anchor within the enclosure to define a stable ladder assembly.

The ladder assembly further preferably comprises a plurality of adjustable bracket assemblies each comprising a strut that slides into the slotted sleeve and is securable therewith. The lower frame is mountable to a wall by the bracket assembly. A frame extension slides within the frame and comprises a pair of side walls and at least one rung. The structures of the side rails of the lower frame each comprise a projecting member and the upper frame side rails have a structure to form a complementary cavity which receives a set projection

### BRIEF DESCRIPTION OF THE DRAWINGS

FIG. 1 is a side sectional view of a retractable ladder assembly below an MCD in a closed position with portions shown in phantom;

FIG. 2 is a side sectional view of a retractable ladder assembly in an open position extending through an MCD with portions shown in phantom;

FIG. 3 is an enlarged top view, partly in section and partly removed, of the retractable ladder assembly in a closed position;

FIG. 4 is a partial annotated perspective view of two supports for the retractable ladder depicted in FIGS. 1 and 2;

FIG. 5A is a sectional annotated view of an enclosure and partial views of related elements compatible with the retractable ladder assembly of FIGS. 1 and 2;

FIG. 5B is a partial perspective view of the MCD of FIG. 1;

FIG. 6A is a side sectional annotated view of the connection between the frames of the retractable ladder assembly during movement into an open position with portions shown in phantom;

FIG. 6B is a side sectional annotated view of the connection between frames of the retractable ladder assembly in the closed position with portions shown in phantom;

FIG. 7 is a side sectional annotated view of an alternative embodiment of a retractable ladder assembly with portions shown in phantom;

FIG. 8 is a side sectional annotated view of the retractable ladder assembly of FIG. 7 in an assembled state;

FIG. 9 is a side sectional annotated view of the retractable ladder assembly of FIG. 7, with portions shown in phantom;

FIG. 10 is a side view and a perspective view of the connection between the upper and lower frame of FIGS. 6A and 6B with portions shown in phantom;

FIG. 11 is a side sectional view and a perspective view of a stop compatible with the retractable ladder assembly;

FIG. 12 is a perspective view of a ladder extension compatible with the retractable ladder assembly;

FIG. 13A is a top sectional annotated view of a portion of an enclosure compatible with the retractable ladder assembly;

FIG. 13B is a top sectional view of a link member compatible with the retractable ladder assembly, with a portion shown in phantom; and

FIG. 13C is a front sectional view of a portion of an upper frame and link member compatible with the retractable ladder assembly.

### DETAILED DESCRIPTION

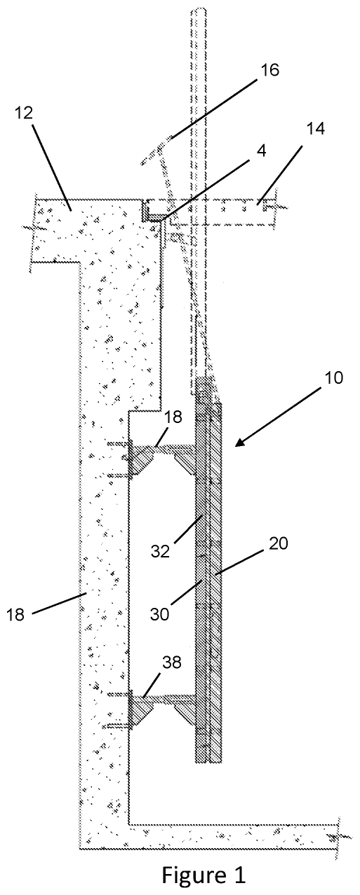

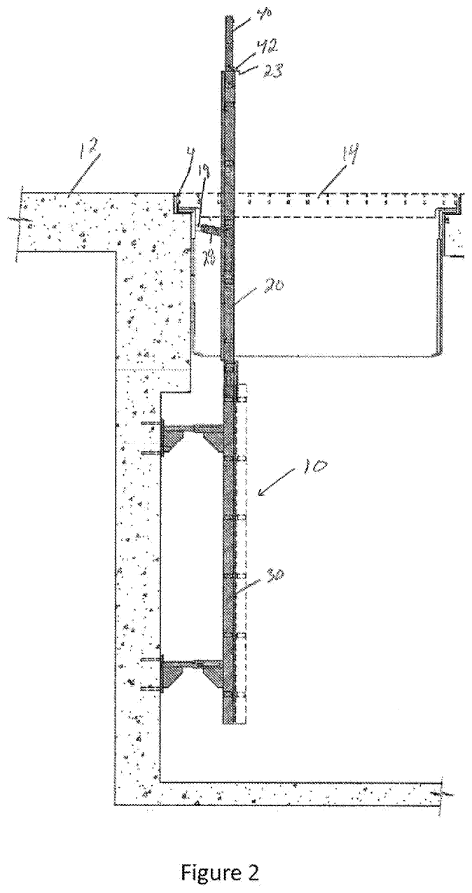

With reference to the drawings wherein like numerals represent like parts throughout the several figures, an MCD is especially adapted for dropping into a below-grade opening, such as for example, a vent opening through a sidewalk (shown generally as 12 in FIGS. 1 and 2) and disposed below a sidewalk grate (shown generally as 14 in FIGS. 1 and 2).

The MCD functions to provide a passage which is normally open, but incorporates a floodgate control assembly (not depicted) which functions in a closed position to prevent the inundation of water through an opening. Although the MCD is especially adapted, for example, for vent shafts in a subway system or other similar type applications, the MCD can clearly be implemented in a wide variety of below grade openings so that it is easily transformable to a floodgate to prevent the inundation of water through the protective opening.

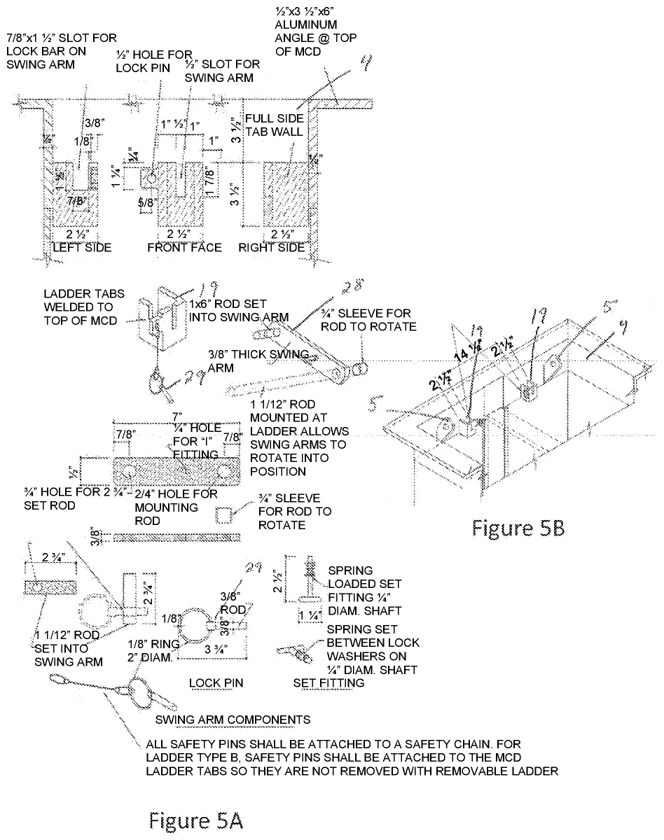

The MCD may be generally described as a four-sided enclosure 4 having an opened top with a peripheral circumferential lip and a bottom portion with an interior inwardly extending flange, which defines a bottom opening. Half-inch thick lifting tabs 5 are mounted to the sides at spaced opposite ends of the enclosure 4 (depicted in FIG. 5B). The lifting tabs 5 are positioned and have sufficient integrity to allow the enclosures 4 to be lifted for installation and removal purposes.

A retractable ladder assembly 10 is especially adapted for placement in and below an opening in the ground that incorporates an MCD. The retractable ladder assembly 10 functions to provide a permanent ladder which is normally in a closed or retracted position, disposed entirely below a grate 14 in a sidewalk or street 12, as depicted in FIG. 1. The retractable ladder assembly 10 is moved to an open or extended position, extending through the enclosure 4, as depicted in FIG. 2.

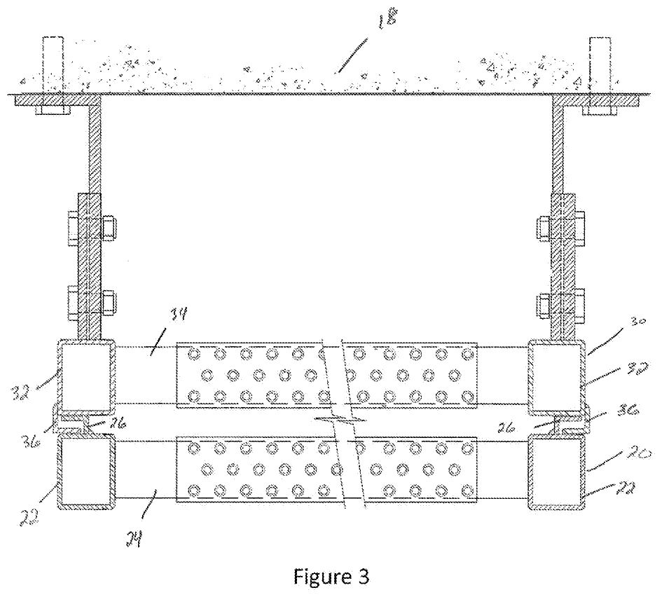

Referring to FIG. 3, the retractable ladder assembly 10 is made up of a lower frame 30 that is fixed to a wall 18 and an upper frame 20 that is supported by the lower frame 30. The “upper” and “lower” designations refer to the open (non-retracted or extended) position of the ladder assembly. The upper and lower frames 20, 30 each comprise vertically extending side rails 22, 32 joined by horizontal rungs 24, 34. The side rails 22, 32 each contain cooperative channel members 26, 36 that laterally retain the upper frame 20 to the lower frame 30 in the horizontal direction and allow movement relative to one another in the generally vertical direction.

A tool for moving the retractable ladder assembly 10 from the closed to open position is generally designated by the numeral 16. The tool 16 has a general T-shape with a rod-like handle and a coupler at the lower portion of a rod-like leg. The tool 16 may also be used to reach through the grate 14 and engage an upper frame 20 of the retractable ladder assembly 10. Once engaged, a user lifts the tool 16 to slide the upper frame 20 vertically upwards towards and through the enclosure 4, moving the retractable ladder assembly 10 from a closed position (depicted in FIG. 1) to an open position (depicted in FIG. 2). In the depicted embodiment, the grate 14 is removed prior to using the tool 16, to allow a user to descend the retractable ladder assembly 10.

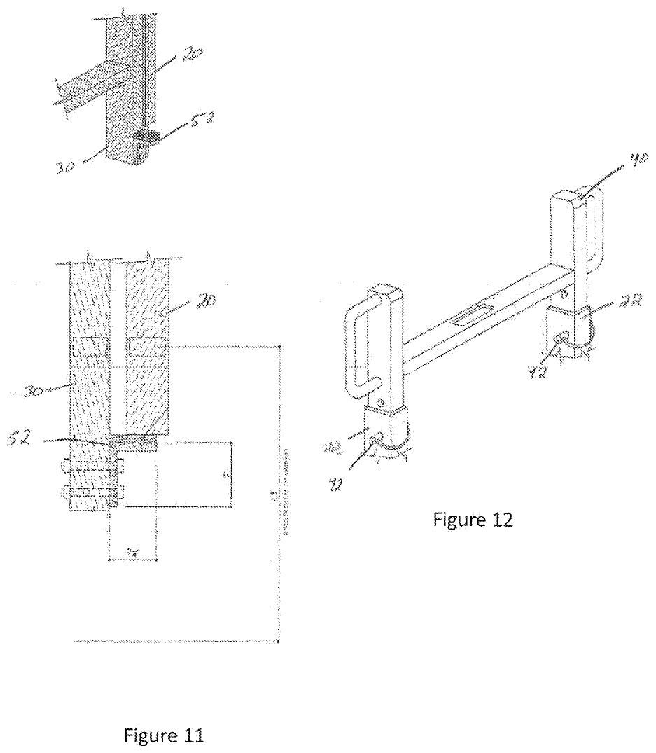

The embodiment depicted in FIG. 2 includes frame extension 40. The frame extension 40 also has side rails and rungs similar to those included in upper frame 20 and lower frame 30. The frame extension 40 is retained between side rails 22 and slides out from the upper or proximal end 23 of the upper frame 20. The frame extension 40 is fixed in an open position by a pin 42 that engages upper frame 20. The frame extension 40 is also depicted in FIG. 12. In one embodiment, the extension has a single rung.

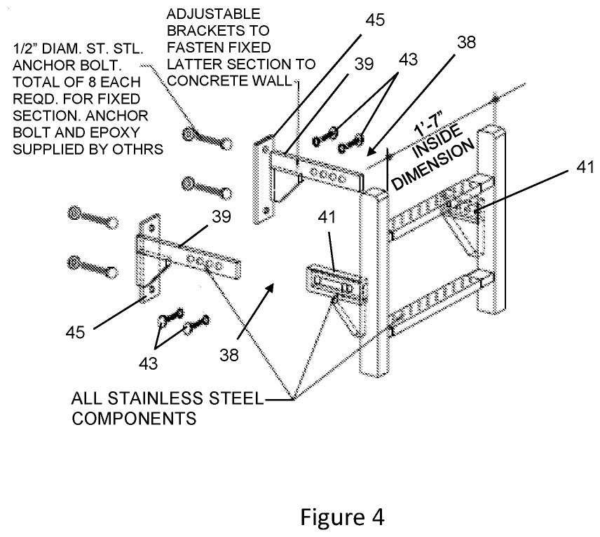

In the embodiment depicted in FIG. 1, the retractable ladder assembly 10 is fixed to the substantially vertical wall 18 below a grate 14 by four adjustable bracket assemblies 38. The depicted adjustable bracket assemblies 38 move horizontally to accommodate a wall that is not entirely vertical and/or to allow the retractable ladder assembly 10 to be mounted at an angle. Such an angle is typically only a few degrees. The horizontal adjustment also allows the retractable ladder assembly 10 to be mounted at different distances from the wall 18 and to accommodate ledges above the retractable ladder assembly 10 (as depicted in FIGS. 1 and 2). The adjustable bracket assembly 38 engages the lower frame 30 at two vertically spaced positions on each side rail 32. In the embodiment depicted in FIG. 4, each siderail 32 is mounted to the wall 18 using only a single adjustable bracket assembly 38. Additional bracket assemblies of various configurations may be employed.

The adjustable bracket assembly 38 is depicted in greater detail in FIG. 4. Each adjustable bracket assembly 38 includes a strut 39 with at least one hole that slides into a slotted sleeve 41. In the depicted embodiment, the slots extend fully through the sleeve 41. The strut 39 is permanently affixed to the wall 18 by mounting plate 45. The slotted sleeve 41 is permanently affixed to the siderail 32 of the lower frame 30. These permanent connections may be reinforced with supports. At least one bolt 43 secures the strut 39 within the slotted sleeve 41. The strut 39 can slide along the slotted sleeve 41 prior to securing with the bolt 43.

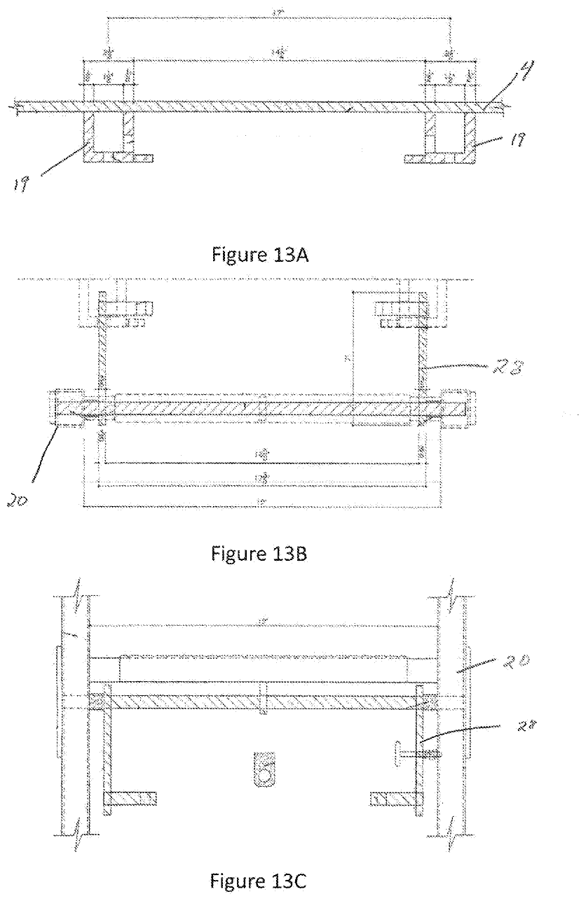

FIG. 2 depicts the retractable ladder assembly in its open or extended position. The upper frame 20 releasably engages an anchor 19 mounted within the enclosure 4 with link member 28. FIG. 5A provides a detailed view of this connection. Link member 28 rotates from a pivot point on the upper frame 20 to engage anchor 19 that is permanently affixed within the enclosure 4 supporting the grate 18. A safety mechanism, such as a pin 29, may be inserted into the joint between the anchor 19 and link member 28 to secure the upper frame 20 to the wall 18 or the anchor 19. In the depicted embodiment, the anchor 19 has a complementary shape to the link member 28. The lifting tabs may also incorporate the anchor into a single element. The anchor 19 and link member 28 are depicted in detail in FIGS. 13A-13C.

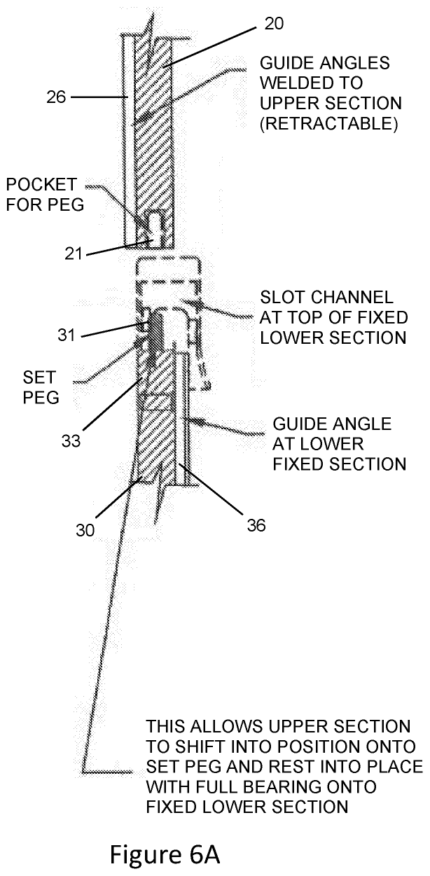

FIGS. 6A and 6B depict the connection between the ends of the lower frame 30 and the upper frame 20 in greater detail. The lower frame 30 vertically or uprightly supports the upper frame 20 in both the open and closed positions. A peg 31 and a coupler 27 extend from the top or proximal end 33 of the lower frame 30 towards the enclosure 4. The bottom or distal end 25 of the upper frame 20 has a pocket 21 with a complementary shape to the peg 31. A tab 29 extends from the proximal end 23 of the upper frame 20. In the closed position, the tab 29 rests in a groove on the proximal end of the lower frame 30.

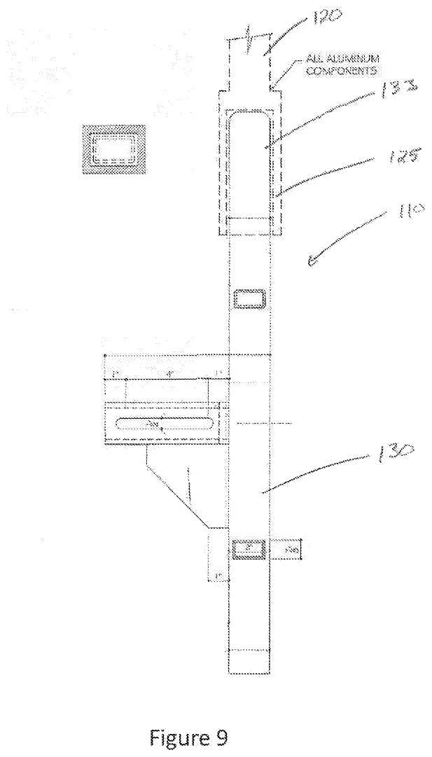

As the user lifts the upper frame 20 vertically or upwardly towards and through the enclosure 4 the channel members 26, 36 retain the frames 20, 30 together in the horizontal direction. The distal end 25 of the upper frame 20 is brought up over and into engagement with the tab 29, and the coupler 27 provides a guide for this movement. The structure of the peg 31 and pocket 21 provide support as a user descends and ascends the retractable ladder 10 in its extended state. This movement of the upper and lower frames 20, 30 is also depicted in FIG. 10.

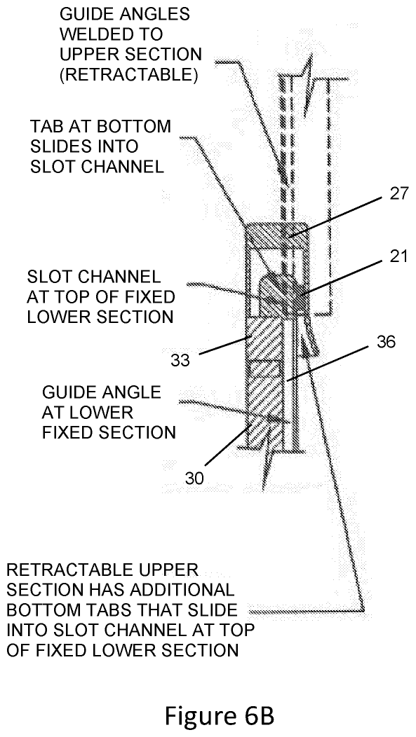

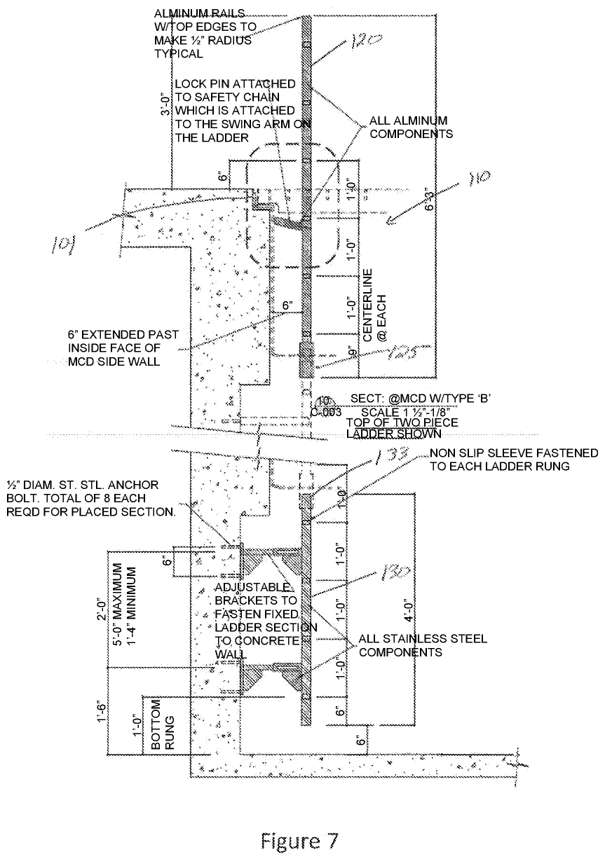

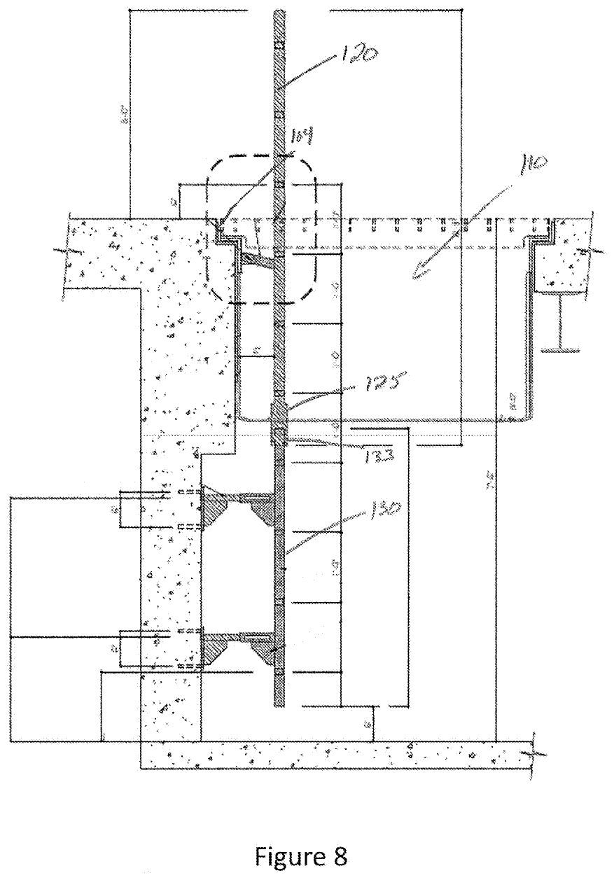

FIGS. 7 and 8 depict an alternate embodiment of the retractable ladder assembly 110. In this embodiment the upper frame 120 is separable from the lower frame 130 and can be removed from the enclosure 4 when not in use. The distal end 125 of the upper frame 120 is hollow to accommodate the projecting proximal end 133 of the lower frame 130. This connection is depicted in detail in FIG. 9.

It should be appreciated that the peg/pocket and projecting/hollow relationship may be reversed relative to the proximal end of the lower frame 30 and distal end of the upper frame 20. The ladder assembly in either the retracted or extended mode is generally upright and may not be precisely vertical, but at a small angle to a vertical axis or plane.

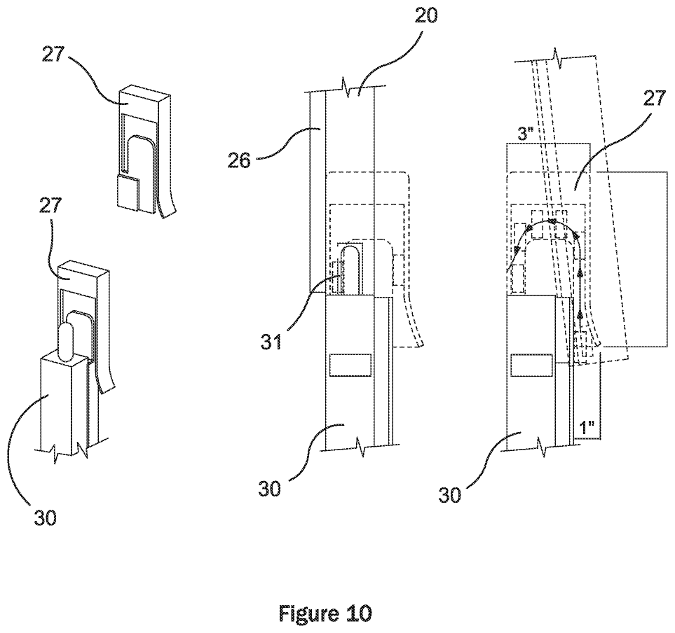

FIG. 11 depicts a stop 52 that is compatible with the retractable ladder assembly 10. The stop 52 mounts to the lower frame 30 and provides a generally vertical limit for the upper frame 20 to rest against in the closed state. The depicted embodiment has a rubber insert attached to the stop 52 to minimize the impact of the upper frame 20.

In one embodiment the lower frame and upper frame are made of the same material. Steel, stainless steel, or other metal alloys may be used depending on the needs of the enclosure and/or the weight of the user. In another embodiment the lower and upper frames are made of different materials, with the upper frame being made of aluminum, an aluminum alloy, or other light metal to put less stress on the user while moving the upper frame.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A retractable ladder assembly mounted to a wall below an enclosure for a mechanical closure device comprising:
a lower frame and an upper frame each having two parallel side rails extending from a proximal end to a distal end along and spaced apart from the wall, a plurality of rungs disposed between said side rails, and a channel member attached to each of said sidewalls;
said lower frame having a plurality of adjustable bracket assemblies mounted to said side rails fixing said lower frame to the wall and a peg projecting towards the enclosure from said proximal end of each of said side rails;
said upper frame having a pocket complementary to said peg at said distal end of each of said side rails, and a link member rotatably secured to said upper frame;
wherein said channel members attached to said lower frame protrude away from the wall, said channel members attached to said upper frame protrude towards the wall, and said channel members of said upper frame and said channel members of said lower frame to retain said upper frame to said lower frame; and
wherein in a retracted position said upper frame is retained to said lower frame, and in an extended position each said peg mates with each said pocket to support said upper frame on said lower frame in a generally upright position and said link member fastens to an anchor within the enclosure.

2. The retractable ladder assembly of claim 1, wherein said upper frame further comprises a frame extension that slides from within said upper frame and locks in an expanded position.

3. The retractable ladder assembly of claim 1, further comprising a pin that fastens said link member to the anchor.

4. The retractable ladder assembly of claim 1 wherein each adjustable bracket assembly comprises a strut that slides into a slotted sleeve, and said strut defines at least one hole which receives a fastener to secure the strut within the slotted sleeve.

5. The retractable ladder assembly of claim 1 wherein when the upper frame is moved to the extended position, the distal end of the upper frame is guided over into engagement with each peg.

6. The retractable ladder assembly of claim 1, further comprising an appendage which further comprises a stop mounted to the lower frame and providing a vertical limit for the upper frame to rest against in the retracted position.

7. The retractable ladder assembly of claim 2 wherein said frame extension further comprises a pair of side walls and at least one rung.

8. The retractable ladder assembly of claim 7 wherein said frame extension is fixed in the expanded position by a pin that engages the upper frame.

9. The retractable ladder assembly of claim 1 further comprising a T-shaped tool having a rod-like handle and a coupler which is engageable with the upper frame for pulling the upper frame toward and through the enclosure.

10. A retractable ladder assembly for use in an enclosure that accommodates a mechanical closure device, comprising:
a lower frame permanently fixable to a wall below the enclosure having a plurality of side rails extending from a proximal end to a distal end and a plurality of rungs extending between said side rails; and
an upper frame having a plurality of side rails extending from a proximal end to a distal end, a plurality of rungs extending between said side rails, and a link member pivotally mounted to the upper frame, each distal end of said upper frame having a first structure complementary to a second structure of each proximal end of said side rails of said lower frame;
wherein in an extended position, each said first structure of said side rails of said upper frame releasably engages each of said second structure of each of said first proximal end of said side rails of said lower frame to support said upper frame on said lower frame and said link member is engageable to an anchor within the enclosure to define a stable installed state.

11. The retractable ladder assembly of claim 10, wherein said upper frame is made from aluminum and said lower frame is made from stainless steel.

12. The retractable ladder assembly of claim 10, wherein a pin secures said link member to the anchor.

13. The retractable ladder assembly of claim 10, wherein said lower frame assembly is mountable to said wall by a plurality of adjustable bracket assemblies, each comprising a strut that slides into a sleeve and is securable therewith.

14. The retractable ladder assembly of claim 10, further comprising a frame extension that slides within said upper frame and comprises a pair of side walls and at least one rung.

15. The retractable ladder assembly of claim 10, wherein each said second structure of said side rails of said lower frame each comprise a projecting member and each said second structure of each distal end of said upper frame comprise forms a generally complementary cavity which receives a said projection.

16. The retractable ladder assembly of claim 10, further comprising a guide structure which guides each distal end of the upper frame over each proximal end of said lower frame for engaging each distal end of said upper frame with each proximal end of said lower frame in an upright supported relationship.

17. A retractable ladder assembly for use in an enclosure that accommodates a mechanical closure device, comprising:
a lower frame permanently fixable to a wall below the enclosure having a pair of side rails extending from a proximal end to a distal end and a plurality of rungs disposed between said side rails; and
an upper frame having a pair of side rails extending from a proximal end to a distal end, a plurality of rungs disposed between said side rails, and a link member rotatably mounted to said upper frame between the proximal end and the distal end, the distal ends of said upper frame having a structure complementary to the proximal ends of said side rails of said lower frame;
retainer structures extending from the lower frame and the upper frame to laterally retain the lower frame and the upper frame in a retracted position and permit sliding movement of said upper frame to an extended position;
wherein said upper frame is slidably movable to the extended position and said structures of said side rails of said upper frame releasably engage the proximal ends of said side rails of said lower frame to support said upper frame on said lower frame in a generally upright orientation and said link member is engageable to an anchor within the enclosure to define a stable extended ladder assembly.

18. The retractable ladder assembly of claim 13, further comprising a plurality of adjustable bracket assemblies, each comprising a strut that slides into a slotted sleeve and is securable therewith, and wherein said lower frame is mountable to a wall by said bracket assembly.

19. The retractable ladder assembly of claim 17, further comprising a frame extension that slides within said upper frame and comprises a pair of side walls and at least one rung.

20. The retractable ladder assembly of claim 17, wherein said structures of said side rails of said lower frame each comprise a projecting member and the upper frame side rails have a structure which forms a generally complementary cavity which receives a said projecting structure.
